(19) United States
(12) Patent Application Publication
(10) Pub. No.: US 2006/0209189 A1
(43) Pub. Date: Sep. 21, 2006

(54) Safty cam

(76) Inventor: Kent William Simpson, Brick, NJ (US)

Correspondence Address: Kent Simpson, 266 A Sawmill Rd., Brick, NJ, 08724, US

(21) Appl. No.: 11/020,070

(22) Filed: Mar. 16, 2005

(51) Int. Cl. H04N 7/18; H04N 9/47

(52) U.S. Cl. 348/148

(57) ABSTRACT

This invention, called the Safety Cam. Is a device that will record accidents as they happen. There is a camera lens located in the rear and front bumper of the vehicle and one by the rear view mirror for a drivers eye view. There will be a little box that will record the entire camera's data. The cameras will start recording once you start the car, and turn off when you turn off the car. The cameras will record in a looping cycle (similar to security video); the looping cycle will be about 20 seconds or more. Once the trigger pins in the bumpers are activated (similar to the triggering of air bags, but a little more sensitive then air bags, so if you hit a person or something, it should record it), the recording will stop. Thus catching everything that happened prior to the triggering of the stop pins, so everything that happened in the last 20 seconds (or more) will be caught on camera. The data will be easy to transfer. The main box in the vehicle will have a memory stick that can be loaded into any computer or digital camera.

### CROSS-REFERENCE TO RELATED APPLICATIONS

Not Applicable

### STATEMENT REGARDING FEDERALL SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

This invention pertains to the automobile industry. It is an invention to improve legal data. It will record accidents as they happen. The data will be visual proof as to what exactly happened at a scene of an accident. This will tell who was really at fault in the occurring accident. The data can be used by the police, lawyers, and in the courts. Insurance fraud will be a little harder, and dosing an accident case will be quicker.

### BRIEF SUMMERY OF THE INVENTION

This device will record accidents as they happen. There is a camera lens located in the rear and front bumper of the vehicle and one by the rear view mirror for a drivers eye view. There will be a little box that will record the entire camera's data. The cameras will start recording once you start the car, and turn off when you turn off the car. The cameras will record in a looping cycle (similar to security video); the looping cycle will be about 20 seconds or more. Once the trigger pins in the bumpers are activated (similar to the triggering of air bags, but a little more sensitive then air bags, so if you hit a person or something, it should record it), the recording will stop. Thus catching everything that happened prior to the triggering of the stop pins, so everything that happened in the last 20 seconds (or more) will be caught on camera. The data will be easy to transfer. The main box in the vehicle will have a memory stick that can be loaded into any computer or digital camera.

### BRIEF DESCRIPTION OF THE SEVERAL VIEWS OF THE DRAWING

Enclosed is an abstract drawing of the Safety Cam.

FIG. 1 shows the whole automobile with the Safety Cam in place. You will see where the looping digital camera will be placed, just under the passenger's side of the dashboard. There is also a description of where the cameras and stop pins will be placed, one behind the rear view mirror (there is no stop pin in the rear view mirror), and one in each (front and rear) bumper, just above the location of the license plate. The camera in the front bumper is also labeled A, which is shown as a close up in FIG. 2.

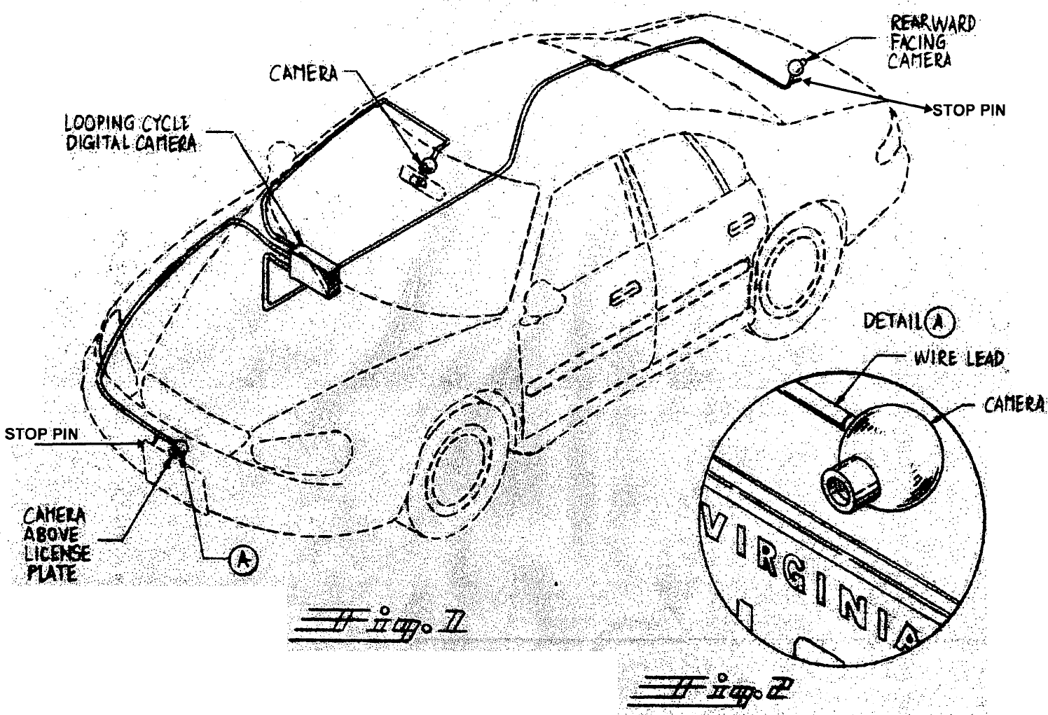

FIG. 2 should give you an idea of the general location and size of the camera.

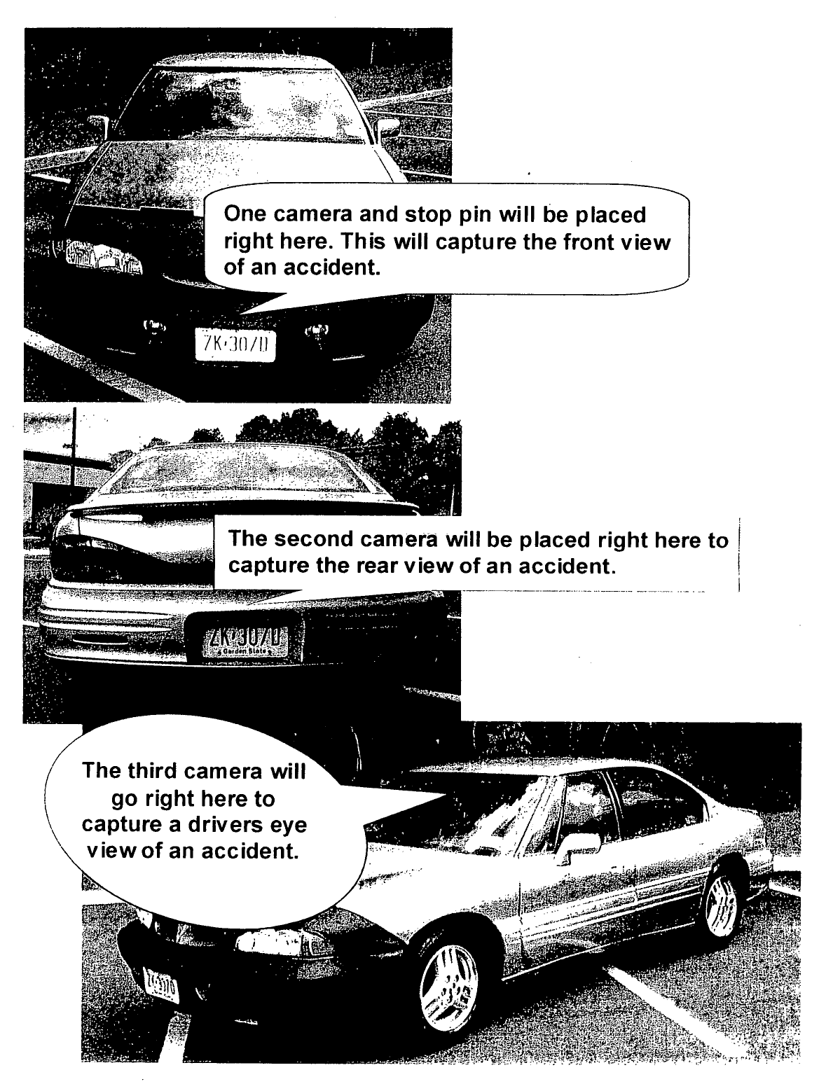

Page three is a photographic description of the Safety Cam. Photo #1 is a front view of where the camera will be placed. Photo #2 is a rear view of where the rear camera will be placed. Photo #3 shows where the rear view camera will be placed.

### DETAILED DESCRIPTION OF THE INVENTION

The digital camera part of this invention will be incased in a plastic box. The plastic box will have all the circuitry, wiring, and everything to make the Safety Cam functional enclosed. The box will have a slot for a memory stick. This memory stick will be removable with ease (just like a regular digital camera) for easy access. There will also be three output plugs labeled mirror, front, and rear. This is where the cameras plug into. The cameras will be on the end of the cable that is plugged into the camera box. The cameras that are to be placed in the bumpers will also have a stop pin attached to the cable. The Safety Cam will be powered by the automobiles power supply. Proper installation of the Safety Cam will record anything you hit or get hit by. Once there is a significant impact on the bumpers, triggering the stop pins, the Safety Cam will stop its loop recording, thus capturing everything that happened 20 seconds ago (or more if loop time is set longer). You will then be able to retrieve the memory stick from the main digital recorder and actually view what happened on any computer. This will prove the innocents or guiltiness the party involved.

Note: Stop pins may also be placed on the side panels of a vehicle.

1. I, Kent Simpson claim as my invention, the Safety Cam. This device will record accidents as they happen. There is a camera lens located in the rear and front bumper of the vehicle and one by the rear view mirror for a drivers eye view. There will be a little box that will record the entire camera's data. The cameras will start recording once you start the car, and turn off when you turn off the car. The cameras will record in a looping cycle (similar to security video); the looping cycle will be about 20 seconds or more. Once the trigger pins in the bumpers are activated (similar to the triggering of air bags, but a little more sensitive then air bags, so if you hit a person or something, it should record it), the recording will stop. Thus catching everything that happened prior to the triggering of the stop pins, so everything that happened in the last 20 seconds (or more) will be caught on camera. The data will be easy to transfer. The main box in the vehicle will have a memory stick that can be loaded into any computer or digital camera.
There will be different models of this device. Some models might have more cameras to cover other angles. Other models might have a manual button in the car somewhere so they can stop the recording manually. Or there might be models that have a memory stick for each camera, or one memory stick, recording in a split view screen.
This will tell who was really at fault in the occurring accident. The data can be used by the police, the lawyers, and in the courts. Insurance fraud will be a little harder, and closing an accident case will be quicker.
